(19) United States
(12) Patent Application Publication
(10) Pub. No.: US 2025/0007279 A1
(43) Pub. Date: Jan. 2, 2025

(54) DISTRIBUTED CIRCUIT FOR ELECTROSTATIC DISCHARGE PROTECTION FOR A SIGNAL PAD

(71) Applicant: Intel Corporation, Santa Clara, CA (US)

(72) Inventors: Susanne Heber, Munich (DE); Daniel Gruber, St. Andrae (AT); Krzysztof Domanski, Neubiberg (DE); Martin Clara, Santa Clara, CA (US)

(73) Assignee: Intel Corporation, Santa Clara, CA (US)

(21) Appl. No.: 18/215,033

(22) Filed: Jun. 27, 2023

(51) Int. Cl. H02H 9/04

(52) U.S. Cl. CPC H02H 9/046

(57) ABSTRACT

An integrated circuit device includes a signal pad, an inductor coupled in series with the signal pad, and an electrostatic discharge (ESD) protection circuit distributed before and after the inductor to provide ESD protection for an ESD event on the signal pad. Other examples are disclosed and claimed.

### BACKGROUND

Electrostatic discharge (ESD) can be harmful to electronics. During an ESD event, charge is transferred from one object to another (e.g., from a person to an integrated circuit (IC)). The transferred charge can result in a high current passing through the IC in a short time, potentially damaging the device. Such ESD events can affect an IC throughout the IC lifetime, including during manufacturing and assembly. Electrostatic discharge (ESD) events that may damage integrated circuits can occur during the manufacturing and assembly of semiconductor devices. An IC may incorporate on-chip ESD protection structures to protect the input, output, and power supply pins of the IC.

There is an ongoing need for improved computational devices to enable ever increasing demand for modeling complex systems, providing reduced computation times, and other considerations. In some contexts, scaling features of ICs has been a driving force for such improvements. Other advancements have been made in materials, device structure, circuit layout, and so on. In particular, there is an ongoing desire to improve ESD protection circuits that are utilized for, in, or otherwise support operation of ICs. It is with respect to these and other considerations that the present improvements have been needed. Such improvements may become critical as the desire to improve computational efficiency become even more widespread.

### BRIEF DESCRIPTION OF THE DRAWINGS

The material described herein is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding or analogous elements, e.g., with the same or similar functionality. The disclosure will be described with additional specificity and detail through use of the accompanying drawings:

FIG. 1 illustrates a block diagram of an example integrated circuit (IC) device that includes a distributed electrostatic discharge (ESD) network;

FIG. 2 illustrates a block diagram of another example IC device that includes a distributed ESD network;

FIG. 3 illustrates a schematic diagram of an example of an interface circuit that includes a distributed low-capacitance ESD (LC-ESD) protection circuit;

FIG. 4 illustrates a schematic diagram of another example of an interface circuit that includes a distributed LC-ESD protection circuit;

FIG. 5 illustrates a block diagram of a system that includes a transceiver with a distributed LC-ESD protection circuit;

FIG. 6 illustrates a diagram of an example data server machine employing an IC device with a distributed LC-ESD protection circuit; and

FIG. 7 is a block diagram of an example computing device, all in accordance with at least some implementations of the present disclosure.

### DETAILED DESCRIPTION

In the following detailed description, reference is made to the accompanying drawings that show, by way of illustration, specific examples in which the claimed subject matter may be practiced. These examples are described in sufficient detail to enable those skilled in the art to practice the subject matter. The various examples, although different, are not necessarily mutually exclusive. For example, a particular feature, structure, or characteristic described herein, in connection with one example, may be implemented within other examples without departing from the spirit and scope of the claimed subject matter.

References within this specification to “one example” or “an example” mean that a particular feature, structure, or characteristic described in connection with the example is included in at least one implementation encompassed within the present description. Therefore, the use of the phrase “one example” or “in an example” does not necessarily refer to the same example. In addition, the location or arrangement of individual elements within each disclosed example may be modified without departing from the spirit and scope of the claimed subject matter. The following detailed description is, therefore, not to be taken in a limiting sense, and the scope of the subject matter is defined only by the appended claims, appropriately interpreted, along with the full range of equivalents to which the appended claims are entitled.

The terms “over,” “to,” “between,” and “on” as used herein may refer to a relative position of one layer with respect to other layers. One layer “over” or “on” another layer or bonded “to” another layer may be directly in contact with the other layer or may have one or more intervening layers. One layer “between” layers may be directly in contact with the layers or may have one or more intervening layers.

The terms “coupled” and “connected.” along with their derivatives, may be used herein to describe structural relationships between components. These terms are not intended as synonyms for each other. Rather, in particular examples, “connected” may be used to indicate that two or more elements are in direct physical or electrical contact with each other. “Coupled” may be used to indicated that two or more elements are in either direct or indirect (with other intervening elements between them) physical or electrical contact with each other, and/or that the two or more elements co-operate or interact with each other (e.g., as in a cause an effect relationship, an electrical relationship, a functional relationship, etc.).

The term “circuit” or “module” may refer to one or more passive and/or active components that are arranged to cooperate with one another to provide a desired function. The term “signal” may refer to at least one current signal, voltage signal, magnetic signal, or data/clock signal. The meaning of “a,” “an,” and “the” include plural references. The meaning of “in” includes “in” and “on.”

The vertical orientation is in the z-direction and recitations of “top,” “bottom,” “above,” and “below” refer to relative positions in the z-dimension with the usual meaning. However, examples are not necessarily limited to the orientations or configurations illustrated in the figure. The term “aligned” (i.e., vertically or laterally) indicates at least a portion of the components are aligned in the pertinent direction while “fully aligned” indicates an entirety of the components are aligned in the pertinent direction.

The terms “substantially,” “close,” “approximately,” “near,” and “about,” generally refer to being within +/−10% of a target value (unless specifically specified). Unless otherwise specified in the specific context of use, the term “predominantly” means more than 50%, or more than half. For example, a composition that is predominantly a first constituent means more than half of the composition is the first constituent. The term “primarily” means the most, or greatest, part. For example, a composition that is primarily a first constituent means the composition has more of the first constituent than any other constituent. A composition that is primarily first and second constituents means the composition has more of the first and second constituents than any other constituent.

Unless otherwise specified, the use of the ordinal adjectives “first,” “second,” and “third,” etc., to describe a common object, merely indicate that different instances of like objects to which are being referred and are not intended to imply that the objects so described must be in a given sequence, either temporally, spatially, in ranking, or in any other manner.

For the purposes of the present disclosure, phrases “A and/or B” and “A or B” mean (A), (B), or (A and B). For the purposes of the present disclosure, the phrase “A, B, and/or C” means (A), (B), (C), (A and B), (A and C), (B and C), or (A, B and C).

Views labeled “cross-sectional,” “profile,” and “plan” correspond to orthogonal planes within a cartesian coordinate system. Thus, cross-sectional and profile views are taken in the x-z and y-z planes, and plan views are taken in the x-y plane. Typically, profile views in the x-z plane are cross-sectional views. Where appropriate, drawings are labeled with axes to indicate the orientation of the figure.

Some integrated circuits (ICs) may utilize diode-based electrostatic discharge (ESD) protection at a pad (e.g., a metallization structure associated with a signal). An ESD protection circuit for a pad may consists of separate instances of a metallized N+/P-well diode (N-diode) and a metallized P+/N-well diode (P-diode) coupled in series between a positive voltage supply (e.g., VDD) and a reference voltage (e.g., VSS or ground) with the anode of the N-diode at VSS. the cathode of the P-diode at VDD, and the pad connected to the junction of the cathode of the N-diode and the anode of the P-diode. Two signal pads may be arranged as two instances of such pad circuits placed next to each other.

To provide ESD protection for Human-Body-Model (HBM) type of ESD stress, where current can be forced between two neighboring pads, relatively large-sized diodes are utilized. To provide ESD protection for Charge-Device-Model (CDM) type of ESD stress, where static charge becomes stored in the IC itself, the ESD diodes may be smaller but may have too much capacitive load for some applications. For example, the capacitive load of ESD networks for high frequency (HF) transceivers utilizing at least one series inductor or a transformer can significantly affect the HF performance. Some HF transceivers may utilize single stage ESD diode protection directly connected at a signal pad of an integrated circuit (IC). A problem is that if the capacitive load at the signal pad is too high, the HF performance significantly deteriorates.

Some HF transceivers may utilize a matching network built with inductors in-package or on-die to provide sufficient ESD protection and HF performance. A problem is that the inductors add extra cost in terms of area and process/design complexity, and the matching bandwidth may be limited.

The capacitive load may be reduced by utilizing smaller ESD diodes, but a problem is that the smaller ESD diodes may not provide sufficient ESD protection at the signal pad. The ESD protection may be improved by adding a series resistor to the smaller diodes, but again a problem is that the HF performance deteriorates if the series resistance is too high.

Some ESD protection circuits for a transceiver with a transformer architecture rely on large primary ESD diodes connected directly at the signal pad. The capacitive load of primary ESD diodes can vary depending on the CDM target. For an example CDM target of six amperes (6 A), the capacitance can reach about one half to one picofarad (0.5-1 pF), depending on the underlying silicon technology. A problem is that, to support a performative HF interfaces at frequencies greater than ten gigahertz (10 GHz), the capacitive load of the ESD protection circuit at a signal pad may more preferably need to be in a range of about one to two hundred femtofarad (100-200 fF).

Some examples may overcome one or more of the foregoing problems. Some examples may provide technology for ESD protection for HF transceivers. In some examples, ESD diodes of a distributed ESD protection circuit are utilized together with the transformer matching network to reduce or minimize the impact of capacitive load on HF performance. In some examples, the ESD network is distributed before and after an inductor coupled to a signal pad. In some examples, a capacitive load of primary diodes of the ESD network may be reduced by utilizing fewer fingers in a multi-finger ESD diode (e.g., only a two-finger primary ESD diode instead of four or more). In some examples, stacked diodes may be utilized to further reduce or minimize the capacitance. Examples may be implemented utilizing any suitable technology including, for example, FinFet or planar technology. Advantageously, the HF performance of the signal pad significantly improves while providing sufficient ESD protection (e.g., for CDM type stress). Another advantage is cost and complexity reduction relative to utilizing an external matching network.

In some examples, the signal pads may only be exposed to CDM type stress. In some examples, the distributed ESD protection circuit provides protection for a signal pad from a static charge stored in an IC itself (e.g., sufficient protection for CDM). For example, the distributed ESD protection circuit may provide protection for the signal pad from a discharge voltage of between five volts and thirty five volts (5-35V).

Some examples provide technology for distributed ESD protection of differential signals with a receiver/transmitter (RX/TX) implemented within sensitive IC devices. The differential signals may be exposed to CDM type of stress during assembly. The CDM stress is assessed to 5-35V of discharge voltage. That CDM voltage is dependent of quality of equipment in assembly line and electrostatic protection level with air ionizers. The CDM voltage may correspond to 40 mA-300 mA of CDM discharge current, depending of voltage level and die size.

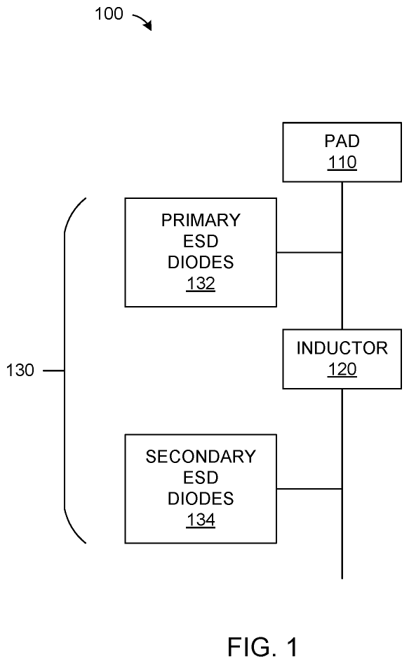

FIG. 1 shows an illustrative block diagram of an example IC device 100 that includes a signal pad 110, an inductor 120 coupled in series with the signal pad 110, and an ESD protection circuit 130 distributed before and after the inductor 120 to provide ESD protection for an ESD event on the signal pad 110. In some examples, the ESD protection circuit 130 may include one or more primary ESD diodes 132 coupled to the signal pad 110 and a first side of the inductor 120, and one or more secondary ESD diodes 134 coupled to a second side of the inductor 120. In some examples, the one or more secondary ESD diodes 134 may provide more ESD protection relative to the one or more primary ESD diodes 132. For example, the one or more secondary ESD diodes 134 may provide a higher capacitive load relative to the one or more primary ESD diodes 132. In some examples, the one or more of the primary ESD diodes 132 and the secondary ESD diodes 134 may be coupled to the signal pad 110 via implicit metallization or explicit resistor coupling the primary diodes 132 and/or the secondary diodes 134 to the signal pad 110.

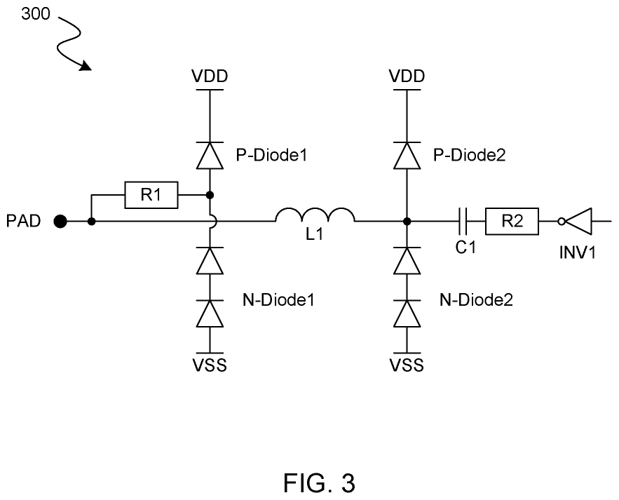

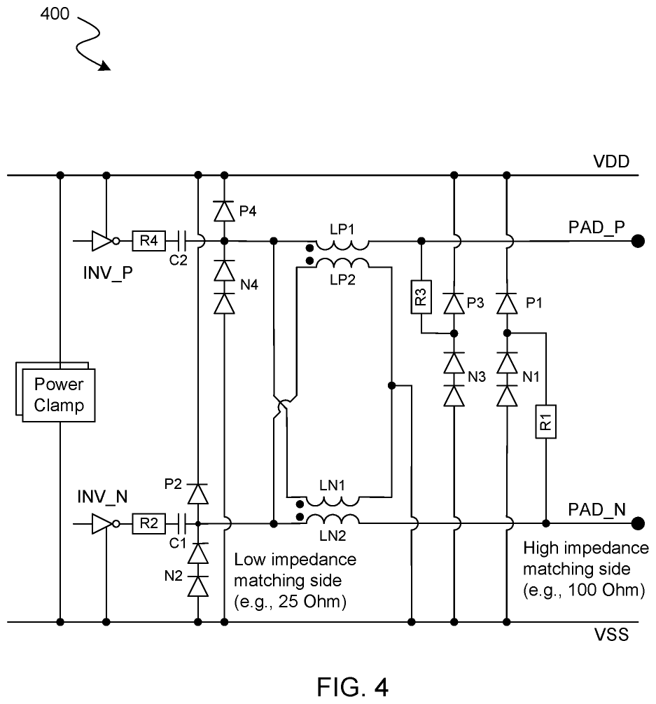

In some examples, the one or more primary ESD diodes 132 may comprise one or more P-diodes coupled in series with one or more N-diodes (e.g., to be coupled between a positive voltage source (e.g., VDD) and a reference voltage source (e.g., VSS or ground; see FIGS. 3 and 4), and a resistor (e.g., see R1 in FIG. 3) coupled between the signal pad 110 and a junction of the one or more P-diodes and the one or more N-diodes. For example, the one or more N-diodes may comprise at least two stacked N-diodes. In any of the examples herein, the signal pad 110 may be to be coupled to a signal with a frequency of at least five (5) GHz (e.g., as part of a HF transceiver).

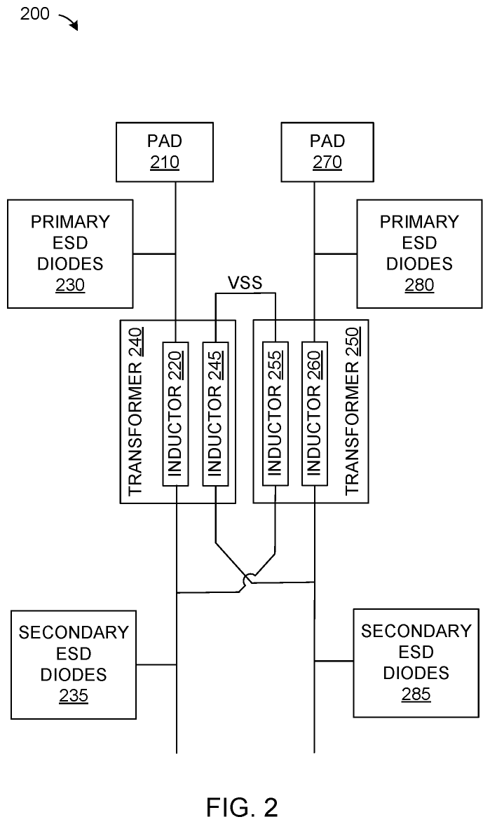

FIG. 2 shows an illustrative block diagram of an examples of an IC device 200 that includes a first signal pad 210, a first inductor 220 coupled in series with the first signal pad 210, a first set of primary ESD diodes 230 coupled to the first signal pad 210 and a first side of the first inductor 220, and a first set of secondary ESD diodes 235 coupled to a second side of the first inductor 220. For example, the first set of secondary ESD diodes 235 may provide a higher capacitive load relative to the first set of primary ESD diodes 230. In some examples, the first set of primary ESD diodes 230 may comprise one or more P-diodes coupled in series with one or more N-diodes (e.g., stacked N-diodes), and a resistor coupled between the first signal pad 210 and a junction of the one or more P-diodes and the one or more N-diodes.

In some examples, the IC device 200 may further comprise a first transformer 240 that comprises the first inductor 220 and a second inductor 245, a second transformer 250 that comprises a third inductor 255 and a fourth inductor 260, a second signal pad 270 coupled in series with the fourth inductor 260, a second set of primary ESD diodes 280 coupled to the second signal pad 270 and a first side of the fourth inductor 260, and a second set of secondary ESD diodes 285 coupled to a second side of the fourth inductor 260. In some examples, a first side of the second inductor 245 is coupled to a first side of the third inductor 255 (e.g., and both are coupled to VSS), a second side of the second inductor 245 is coupled to the second side of the fourth inductor 260, and a second side of the third inductor 255 is coupled to the second side of the first inductor 220.

In some examples, the second set of secondary ESD diodes 285 provide a higher capacitive load relative to the second set of primary ESD diodes 280. In some examples, the second set of primary ESD diodes 280 may comprise one or more P-diodes coupled in series with one or more N-diodes (e.g., stacked N-diodes). In some examples, the first and second pads 210, 270 may be to be respectively coupled to a differential pair of signals with a frequency of at least 5 GHz.

Some examples provide technology for ESD protection for a HF transceiver. In some examples, a circuit provides low capacitance ESD (LC-ESD) protection for receiver and/or transmitters that are exposed to external HF signals.

FIG. 3 shows a schematic diagram of an example interface circuit 300 that includes LC-ESD protection for a connection PAD for a HF signal, resistors R1, R2, inductor L1, capacitor C1, inverter INV1, P-diodes P-Diode1, P-Diode2, and N-diode stacks N-Diode1, N-Diode2, coupled as shown. In this example, the external facing ESD diodes P-Diode1 and N-Diode1 on the PAD side of the inductor LI may be considered the primary ESD diodes, while the ESD diodes P-Diode2 and N-Diode2 on the other side of the inductor L1 may be considered the secondary ESD diodes.

In this example, the ESD network is distributed before and after the inductor L1 with reduced primary diode protection connected to PAD via the resistor R1. Advantageously, the reduced primary diode protection has a lower capacitance value as compared to full ESD protection directly at the PAD. The resistor R1 reduces the current through the primary ESD diodes to an amount of current that is lower than the damage value. The primary ESD diodes are reduced in size and connected with the series resistor R1. The resistance of the inductor L1 is much less than the resistance of the resistor R1. For example, the inductor L1 may have 2 nanohenry inductance and five ohms resistance (2 nH, 5 Ω), while the resistor R1 may have twenty-five ohms resistance (25 Ω). Accordingly, the main current path from an ESD event is redirected from the primary ESD diodes to the secondary ESD diodes and the inductor L1. Other examples, may have more or less resistance and/or inductance selected to meet various design requirements while directing most of the ESD current through the secondary ESD diodes.

The primary ESD diodes may utilize fewer fingers (e.g., relative to full ESD protection directly at the PAD) to reduce the capacitive load. In FIG. 3, the N-diodes in the ESD path are stacked to reduce capacitive load and to allow higher signal swing below VSS voltage. In other examples, a single N-diode may be utilized. Given the benefit of the present specification and drawings, those skilled in the art will appreciate that a wide variety of ESD protection circuits may be utilized with the ESD network distributed before and after the inductor. Further variants of the LC-ESD protection circuit may include different stacking of the diodes such as, for example, not stacked N-diode/P-diode, stacked P-diode/not stacked N-diode, three times (3×) or higher series stacks of diodes for N-diode and/or P-diode, etc. Similarly, in different examples the ESD victim may be decoupled via a capacitor or not. The exemplary victim from FIG. 3 may be replaced by any other suitable victim architecture.

FIG. 4 shows a schematic diagram of an example interface circuit 400 that includes a LC-ESD protection circuit for a pair of connection pads PAD_P and PAD_N for HF differential signals. As compared to the single PAD example of FIG. 3, the circuit 400 further includes an inductive coupling network between PAD_N and PAD_P. The circuit 400 provides LC-ESD protection for receivers and/or transmitters that are exposed to external HF differential signals. In particular, the circuit 400 includes resistors R1, R2, R3, R4, inductors LN1, LN2, LP1, LP2, capacitors C1, C2, inverters INV_N, INV_P, P-diodes P1, P2, P3, P4, N-diode stacks N1, N2, N3, N4, and power clamps, coupled as shown. In this example, the P-diode P1 and the N-diodes N1 may be considered to be a first set of primary ESD diodes for PAD_N, the P-diode P3 and the N-diodes N3 may be considered to be a second set of primary ESD diodes for PAD_P, the P-diode P2 and N-diodes N2 may be considered to be a first set of secondary ESD diodes for PAD_N, and the P-diode P4 and N-diodes N4 may be considered to be a second set of secondary ESD diodes for PAD_P.

In some examples, the circuit 400 may be utilized as an architecture of ESD network differential for a HF transmitter. The distributed ESD network utilizes a reduced primary diode protection connected to the connection pads via a resistor. When an ESD event occurs, reduced CDM current flows through the small primary diodes shielded by the corresponding resistor for current limitation. In some examples, the first set of primary diodes P1, N1 and the second set of primary diodes P3, N3 may be implemented as x2 finger in parallel diodes. As shown in FIG. 4, large second stage ESD diodes (e.g., secondary ESD diodes P2, N2 and P4, N4) shunt about half of the CDM current, with the secondary ESD diodes codesigned after the inductors for better impedance match and reduced capacitive load before the inductors. In some examples, the first set of secondary diodes P2, N2 and the second set of secondary diodes P4, N4 may be implemented as x4 finger in parallel diodes. The inductors provide another CDM current path for about half of the CDM current (e.g., via coils with 2 nH of inductance and ten ohms (2×5=10Ω) resistance).

In some applications, the worst case CDM discharge occurs in the negative CDM stress, where positive current is forced to the connection pad. When a positive current is forced into the PAD_N versus VSS, an example CDM stress may have a magnitude up to about six amps (6 A), and slew-rates in a range of about twenty to one hundred picoseconds (20-100 ps). With full ESD protection provided directly at the connection pad, the major part of the currents from an ESD event flows through the ESD diodes via power clamp to VSS. The ESD diodes typically have resistance that is less than 1 ohm (<1Ω). The current path to VSS via inductors may have about ten ohms (˜10Ω) of series resistance and accordingly drives only a fraction of current from an ESD event. With full ESD protection provided directly at the connection pad, the ESD diodes are dimensioned for substantially all of the current from an ESD event. In some devices, the voltage at PAD_N and PAD_P may be clamped by twelve-finger (x12) in parallel ESD diodes that prevent the victims from damage. With the full ESD protection at PAD_N and PAD_P, the capacitive load is high and becomes problematic as the frequency of the signals on the pads increases.

In contrast with full ESD protection at the pad, the circuit 400 includes the LC-ESD protection circuit with the ESD network distributed before and after the inductors. In some examples, the high-capacitive load of primary diodes at HF PAD_N/P may be significantly reduced from twelve-finger (x12) to two-finger (x2) of ESD diodes. Stacked diodes may also be utilized to further reduce or minimize the capacitance. As a result, the HF performance of PAD_N and PAD_P is significantly improved. The 2x stacked N-diodes also provide overvoltage tolerance in range of four-tenths volt to one-half volt (0.4-0.5V, or higher depending on tolerated current load at the HF pad) per diode for negative voltage signals at PAD_N and PAD_P. In some examples, PAD_N and PAD_P may be minus one volt (−1V) overvoltage tolerant.

The primary ESD diodes are decoupled by respective resistors R1 and R3 from PAD_N and PAD_P. The primary ESD diodes are not sized to drive the bulk of the ESD current. Instead, the primary ESD diodes with the resistors R1, R3 are sized to suppress the overshoots at PAD_N or PAD_P only. For example, the primary ESD diodes may also be dimensioned to drive only a residual part of current forced in CDM at PAD_N or PAD_P. The resistance value of the resistors R1, R3 may be selected to reduce the current through the respective primary ESD diodes to an amount of current that is lower than a predetermined amount (e.g., based on damage prevention). In some examples, the resistors R1 and R3 may have a resistance of about twenty five ohms (25Ω), but they may have any suitable resistance value based on design requirements.

The primary ESD diodes are reduced in size and connected with a nominal series resistance (e.g., R1=25Ω). The secondary ESD diodes are connected after inductors, and are dimensioned to drive approximately half of the CDM current. The main CDM current path is redirected from the primary ESD diodes to the secondary ESD diodes and the inductors. For an ESD event on PAD_N, for example, approximately half of the CDM current (˜3 A) flows along a first ESD path through the inductance LN2 to the second stage ESD diodes P2, N2 and is shunted to VSS via the power clamp, and approximately half of the CDM current (˜3 A) flows via a parallel second ESD path through both inductors LN2 and LP2 to VSS (e.g., and correspondingly, secondary diodes P4, N4 drive about half of the CDM current and LNI and LP1 drive about half of the CDM current in stress of PAD_P).

A residual CDM current still flows along a third ESD path via primary ESD diodes P1, N1 decoupled by the resistor R1. The primary ESD diodes are significantly reduced in size (e.g., from 12x to 2x fingers). Without some ESD protection directly at the connection pads, an overshoot at the connection pad may exceed the limits of breakdown voltage for isolation between metal lines and cause electrostatic overstress driven damage. The series resistor R1 and primary ESD diodes P1, N1 may be dimensioned to clip the overshoots at PAD_N only. Advantageously, the distributed ESD network provides the needed ESD protection at the connection pad while allowing the size of the primary ESD diodes to be substantially reduced.

The inductors LN1, LN2, LP1, LP2 provide functional aspects of the circuit 400, and may have any suitable value (e.g., in this example each of the inductors LN1, LN2, LP1, LP2 may have 5Ω and 2 nH). The (transformer) matching network provides a reduced impedance level (e.g. ˜5Ω of resistive part in LN2) on the secondary side of the ESD network (e.g., the secondary ESD diodes P2, N2). Thus, the secondary ESD diodes (e.g., with increased capacitive loading), can be larger than the primary ESD diodes (e.g., P1, N1 via ˜25 Ohm of resistive part of R1), without significantly impacting the performance.

In some examples, the topology of the circuit 400 may be utilized for impedance matching networks providing N:M impedance transformation and including at least one direct current (DC) coupled path between matching network input/output. The bigger ESD protection of the secondary ESD diodes is applied at the low impedance side (e.g., see 25 Ohm side in FIG. 4). During worst-case negative CDM stress, the positive current is driven by p-diodes of the primary ESD diodes and the secondary ESD didoes via power-clamp to source of CDM charge at ground (VSS). In some examples, the N-diodes in the ESD path are stacked to reduce capacitive load and to allow higher signal swing below VSS voltage. In other examples, a single N-diode may be utilized and/or any other suitable stacked/non-stacked arrangement of the P-diodes and N-diodes may be utilized. The ESD victim may be decoupled via capacitance and may consist of a ballasted inverter. Alternatively, for RX/TX different victims may be utilized and/or the decoupling capacitor may be utilized or not.

As compared to a HF network without ESD, a HF network that incorporates full ESD protection at the pad may induce significant degradation of return loss, particularly at frequencies of 5 GHz and above. As compared to a HF network without ESD, examples of a HF network that incorporates a LC-ESD protection circuit with a distributed ESD network as described herein may exhibit substantially similar performance in terms of return loss and bandwidth. Advantageously, examples may provide sufficient ESD protection with little or no impact on performance at frequencies of 5 GHz and above.

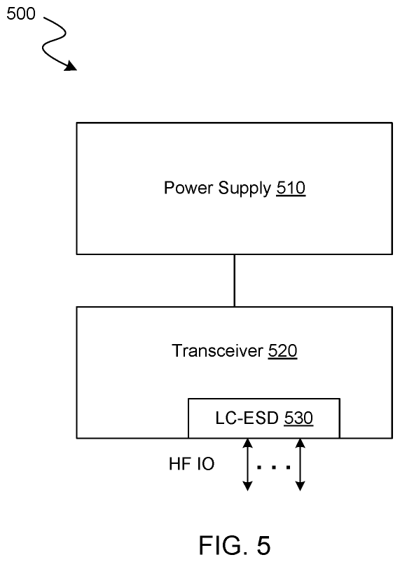

FIG. 5 shows a block diagram of an example of a system 500 that includes a power supply 510 to provide a positive voltage source and a reference voltage source, and a transceiver 520 coupled to the power supply. The transceiver 520 includes a distributed LC-ESD protection circuit 530 that incorporates one or more features or aspects of the examples described herein.

For example, the transceiver 520 may comprise a first signal pad to be coupled to a first signal of a differential signal pair, a second signal pad to be coupled to a second signal of the differential signal pair, a transformer coupled to the first and second signal pads, and an ESD network distributed before and after the transformer to provide ESD protection for an ESD event on one or more of the first signal pad and the second signal pad. In some examples, the ESD network may comprise a first set of primary ESD diodes coupled to the first signal pad through a first resistor and coupled to a first side of the transformer to provide a first ESD path for the ESD event on the first signal pad through the first set of primary ESD diodes, and a first set of secondary ESD diodes coupled to a second side of the transformer to provide a second ESD path for the ESD event on the first signal pad through the first set of secondary ESD diodes.

For example, the first set of primary ESD diodes and the first resistor may be dimensioned to carry less than half of an amount of current from the ESD event on the first signal pad (e.g., or less than one-tenth of the amount of current from the ESD event). In some examples, the transformer may be further to provide a third ESD path for the ESD event on the first signal pad through the transformer. For example, the first set of primary ESD diodes and the first resistor may be dimensioned to carry a residual amount of current from the ESD event on the first signal pad not carried by the second and third ESD paths.

In some examples, the ESD network may further comprise a second set of primary ESD diodes coupled to the second signal pad through a second resistor and coupled to the first side of the transformer to provide a fourth ESD path for the ESD event on the second signal pad through the second set of primary ESD diodes, and a second set of secondary ESD diodes coupled to the second side of the transformer to provide a fifth ESD path for the ESD event on the second signal pad through the second set of secondary ESD diodes. For example, the second set of primary ESD diodes and the second resistor may be dimensioned to carry less than half of an amount of current from the ESD event on the second signal pad. In some examples, the transformer may be further to provide a sixth ESD path for the ESD event on the second signal pad through the transformer. For example, the second set of primary ESD diodes and the second resistor may be dimensioned to carry a residual amount of current from the ESD event on the second pad not carried by the fifth and sixth ESD paths.

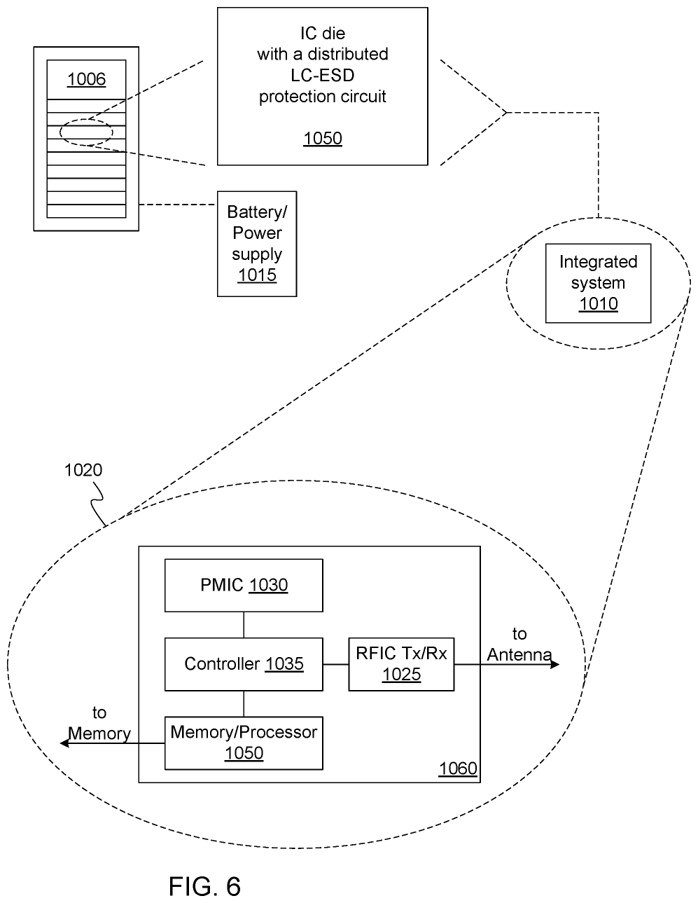

FIG. 6 illustrates a diagram of an example data server machine 1006 employing an IC device 1050 with a distributed LC-ESD protection circuit as described herein, in accordance with some examples. Server machine 1006 may be any commercial server, for example, including any number of high-performance computing platforms disposed within a rack and networked together for electronic data processing, that in the exemplary example includes one or more devices 1050 having one or more distributed LC-ESD protection circuits.

Also as shown, server machine 1006 includes a battery and/or power supply 1015 to provide power to devices 1050, and to provide, in some examples, power delivery functions such as power regulation. Devices 1050 may be deployed as part of a package-level integrated system 1010. Integrated system 1010 is further illustrated in the expanded view 1020. In the exemplary example, devices 1050 (labeled “Memory/Processor”) includes at least one memory chip (e.g., RAM), and/or at least one processor chip (e.g., a microprocessor, a multi-core microprocessor, or graphics processor, or the like) having the characteristics discussed herein. In an example, device 1050 is a microprocessor including a cache memory. As shown, device 1050 may be a multi-chip module employing one or more IC devices with one or more distributed LC-ESD protection circuits, as discussed herein. Device 1050 may be further coupled to (e.g., communicatively coupled to) a board, an interposer, or a substrate 1060 along with, one or more of a power management IC (PMIC) 1030, RF (wireless) IC (RFIC) 1025, including a wideband RF (wireless) transmitter and/or receiver (TX/RX) (e.g., including a digital baseband and an analog front end module further comprises a power amplifier on a transmit path and a low noise amplifier on a receive path), and a controller 1035 thereof. In some examples, RFIC 1025, PMIC 1030, controller 1035, and device 1050 include IC devices having a distributed LC-ESD protection circuit on substrate 1060 in a multi-chip module.

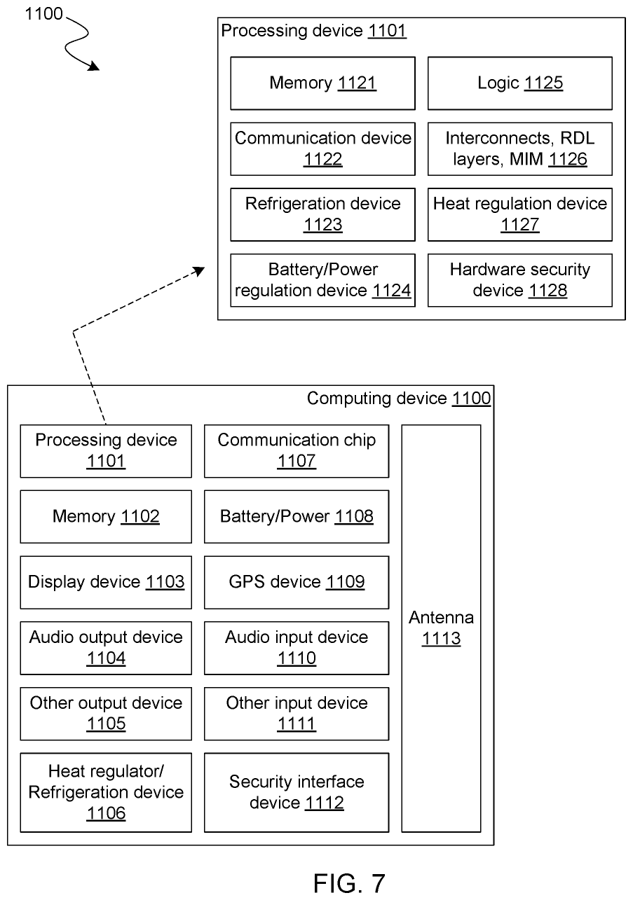

FIG. 7 is a block diagram of an example computing device 1100, in accordance with some examples. For example, one or more components of computing device 1100 may include any of the devices or structures discussed herein. A number of components are illustrated in FIG. 7 as being included in computing device 1100, but any one or more of these components may be omitted or duplicated, as suitable for the application. In some examples, some or all of the components included in computing device 1100 may be attached to one or more printed circuit boards (e.g., a motherboard). In some examples, various ones of these components may be fabricated onto a single system-on-a-chip (SoC) die. Additionally, in various examples, computing device 1100 may not include one or more of the components illustrated in FIG. 7, but computing device 1100 may include interface circuitry for coupling to the one or more components. For example, computing device 1100 may not include a display device 1103, but may include display device interface circuitry (e.g., a connector and driver circuitry) to which display device 1103 may be coupled. In another set of examples, computing device 1100 may not include an audio output device 1104, other output device 1105, global positioning system (GPS) device 1109, LTE device, 5G device, 6G device, 5G beam forming device, audio input device 1110, or other input device 1111, but may include audio output device interface circuitry, other output device interface circuitry, GPS device interface circuitry, LTE, 5G, 6G interface circuitry, audio input device interface circuitry, audio input device interface circuitry, to which audio output device 1104, other output device 1105, GPS device 1109, audio input device 1110, or other input device 1111 may be coupled.

Computing device 1100 may include a processing device 1101 (e.g., one or more processing devices). As used herein, the term “processing device” or “processor” indicates a device that processes electronic data from registers and/or memory to transform that electronic data into other electronic data that may be stored in registers and/or memory. Processing device 1101 may include a memory 1121, a communication device 1122, a refrigeration device 1123, a battery/power regulation device 1124, logic 1125, interconnects 1126 (i.e., optionally including redistribution layers (RDL) or metal-insulator-metal (MIM) devices), a heat regulation device 1127, and a hardware security device 1128.

Processing device 1101 may include one or more digital signal processors (DSPs), application-specific ICs (ASICs), central processing units (CPUs), graphics processing units (GPUs), cryptoprocessors (specialized processors that execute cryptographic algorithms within hardware), server processors, or any other suitable processing devices.

Computing device 1100 may include a memory 1102, that may itself include one or more memory devices such as volatile memory (e.g., dynamic random-access memory (DRAM)), nonvolatile memory (e.g., read-only memory (ROM)), flash memory, solid state memory, and/or a hard drive. In some examples, memory 1102 includes memory that shares a die with processing device 1101. This memory may be used as cache memory and may include embedded dynamic random-access memory (eDRAM) or spin transfer torque magnetic random-access memory (STT-M RAM).

Computing device 1100 may include a heat regulation/refrigeration device 1106. Heat regulation/refrigeration device 1106 may maintain processing device 1101 (and/or other components of computing device 1100) at a predetermined low temperature during operation. This predetermined low temperature may be any temperature discussed herein.

In some examples, computing device 1100 may include a communication chip 1107 (e.g., one or more communication chips). For example, the communication chip 1107 may be configured for managing wireless communications for the transfer of data to and from computing device 1100. The term “wireless” and its derivatives may be used to describe circuits, devices, systems, methods, techniques, communications channels, etc., that may communicate data through the use of modulated electromagnetic radiation through a nonsolid medium. The term does not imply that the associated devices do not contain any wires, although in some examples they might not.

Communication chip 1107 may implement any of a number of wireless standards or protocols, including but not limited to Institute for Electrical and Electronic Engineers (IEEE) standards including Wi-Fi (IEEE 802.11 family), IEEE 802.16 standards (e.g., IEEE 802.16-2005 Amendment), Long-Term Evolution (LTE) project along with any amendments, updates, and/or revisions (e.g., advanced LTE project, ultramobile broadband (UMB) project (also referred to as “3GPP2”), etc.). IEEE 802.16 compatible Broadband Wireless Access (BWA) networks are generally referred to as WiMAX networks, an acronym that stands for Worldwide Interoperability for Microwave Access, that is a certification mark for products that pass conformity and interoperability tests for the IEEE 802.16 standards. Communication chip 1107 may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. Communication chip 1107 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). Communication chip 1107 may operate in accordance with Code Division Multiple Access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, 6G, and beyond. Communication chip 1107 may operate in accordance with other wireless protocols in other examples. Computing device 1100 may include an antenna 1113 to facilitate wireless communications and/or to receive other wireless communications (such as AM or FM radio transmissions).

In some examples, communication chip 1107 may manage wired communications, such as electrical, optical, or any other suitable communication protocols (e.g., the Ethernet). As noted above, communication chip 1107 may include multiple communication chips. For instance, a first communication chip 1107 may be dedicated to shorter-range wireless communications such as Wi-Fi or Bluetooth, and a second communication chip 1107 may be dedicated to longer-range wireless communications such as GPS, EDGE, GPRS, CDMA, WiMAX, LTE, EV-DO, or others. In some examples, a first communication chip 1107 may be dedicated to wireless communications, and a second communication chip 1107 may be dedicated to wired communications.

Computing device 1100 may include battery/power circuitry 1108. Battery/power circuitry 1108 may include one or more energy storage devices (e.g., batteries or capacitors) and/or circuitry for coupling components of computing device 1100 to an energy source separate from computing device 1100 (e.g., AC line power).

Computing device 1100 may include a display device 1103 (or corresponding interface circuitry, as discussed above). Display device 1103 may include any visual indicators, such as a heads-up display, a computer monitor, a projector, a touchscreen display, a liquid crystal display (LCD), a light-emitting diode display, or a flat panel display, for example.

Computing device 1100 may include an audio output device 1104 (or corresponding interface circuitry, as discussed above). Audio output device 1104 may include any device that generates an audible indicator, such as speakers, headsets, or earbuds, for example.

Computing device 1100 may include an audio input device 1110 (or corresponding interface circuitry, as discussed above). Audio input device 1110 may include any device that generates a signal representative of a sound, such as microphones, microphone arrays, or digital instruments (e.g., instruments having a musical instrument digital interface (MIDI) output).

Computing device 1100 may include a GPS device 1109 (or corresponding interface circuitry, as discussed above). GPS device 1109 may be in communication with a satellite-based system and may receive a location of computing device 1100, as known in the art.

Computing device 1100 may include other output device 1105 (or corresponding interface circuitry, as discussed above). Examples of the other output device 1105 may include an audio codec, a video codec, a printer, a wired or wireless transmitter for providing information to other devices, or an additional storage device.

Computing device 1100 may include other input device 1111 (or corresponding interface circuitry, as discussed above). Examples of the other input device 1111 may include an accelerometer, a gyroscope, a compass, an image capture device, a keyboard, a cursor control device such as a mouse, a stylus, a touchpad, a bar code reader, a Quick Response (QR) code reader, any sensor, or a radio frequency identification (RFID) reader.

Computing device 1100 may include a security interface device 1112. Security interface device 1112 may include any device that provides security measures for computing device 1100 such as intrusion detection, biometric validation, security encode or decode, access list management, malware detection, or spyware detection.

Computing device 1100, or a subset of its components, may have any appropriate form factor, such as a hand-held or mobile computing device (e.g., a cell phone, a smart phone, a mobile internet device, a music player, a tablet computer, a laptop computer, a netbook computer, a personal digital assistant (PDA), an ultramobile personal computer, etc.), a desktop computing device, a server or other networked computing component, a printer, a scanner, a monitor, a set-top box, an entertainment control unit, a vehicle control unit, a digital camera, a digital video recorder, or a wearable computing device.

The subject matter of the present description is not necessarily limited to specific applications illustrated in FIGS. 1-7. The subject matter may be applied to other transistor applications, as well as any appropriate manufacturing application, as will be understood to those skilled in the art.

The following examples pertain to further examples, and specifics in the examples may be used anywhere in one or more examples.

Example 1 includes an integrated circuit (IC) device, comprising a signal pad, an inductor coupled in series with the signal pad, and an electrostatic discharge (ESD) protection circuit distributed before and after the inductor to provide ESD protection for an ESD event on the signal pad.

Example 2 includes the IC device of Example 1, wherein the ESD protection circuit comprises one or more primary ESD diodes coupled to the signal pad and a first side of the inductor, and one or more secondary ESD diodes coupled to a second side of the inductor.

Example 3 includes the IC device of Example 2, wherein the one or more secondary ESD diodes provide more ESD protection relative to the one or more primary ESD diodes.

Example 4 includes the IC device of any of Examples 2 to 3, wherein the one or more secondary ESD diodes provide a higher capacitive load relative to the one or more primary ESD diodes.

Example 5 includes the IC device of any of Examples 2 to 4, wherein the one or more primary ESD diodes comprise one or more P-diodes coupled in series with one or more N-diodes, and a resistor coupled between the signal pad and a junction of the one or more P-diodes and the one or more N-diodes.

Example 6 includes the IC device of Example 5, wherein the one or more N-diodes comprise at least two stacked N-diodes.

Example 7 includes the IC device of any of Examples 1 to 6, wherein the signal pad is to be coupled to a signal with a frequency of at least five gigahertz.

Example 8 includes an integrated circuit (IC) device, comprising a first signal pad, a first inductor coupled in series with the first signal pad, a first set of primary ESD diodes coupled to the first signal pad and a first side of the first inductor, and a first set of secondary ESD diodes coupled to a second side of the first inductor.

Example 9 includes the IC device of Example 8, wherein the first set of secondary ESD diodes provide a higher capacitive load relative to the first set of primary ESD diodes.

Example 10 includes the IC device of Example 9, wherein the first set of primary ESD diodes comprise one or more P-diodes coupled in series with one or more N-diodes, and a resistor coupled between the first signal pad and a junction of the one or more P-diodes and the one or more N-diodes.

Example 11 includes the IC device of any of Examples 8 to 10, further comprising a first transformer that comprises the first inductor and a second inductor, a second transformer that comprises a third inductor and a fourth inductor, a second signal pad coupled in series with the fourth inductor, a second set of primary ESD diodes coupled to the second signal pad and a first side of the fourth inductor, and a second set of secondary ESD diodes coupled to a second side of the fourth inductor.

Example 12 includes the IC device of Example 11, wherein a first side of the second inductor is coupled to a first side of the third inductor, a second side of the second inductor is coupled to the second side of the fourth inductor, and a second side of the third inductor is coupled to the second side of the first inductor.

Example 13 includes the IC device of any of Examples 11 to 12, wherein the second set of secondary ESD diodes provide a higher capacitive load relative to the second set of primary ESD diodes.

Example 14 includes the IC device of any of Examples 11 to 13, wherein the first and second pads are to be respectively coupled to a differential pair of signals with a frequency of at least five gigahertz.

Example 15 includes a system, comprising a power supply to provide a positive voltage source and a reference voltage source, and a transceiver coupled to the power supply, the transceiver comprising a first signal pad to be coupled to a first signal of a differential signal pair, a second signal pad to be coupled to a second signal of the differential signal pair, a transformer coupled to the first and second signal pads, and an electrostatic discharge (ESD) network distributed before and after the transformer to provide ESD protection for an ESD event on one or more of the first signal pad and the second signal pad.

Example 16 includes the system of Example 15, wherein the ESD network comprises a first set of primary ESD diodes coupled to the first signal pad through a first resistor and coupled to a first side of the transformer to provide a first ESD path for the ESD event on the first signal pad through the first set of primary ESD diodes, and a first set of secondary ESD diodes coupled to a second side of the transformer to provide a second ESD path for the ESD event on the first signal pad through the first set of secondary ESD diodes.

Example 17 includes the system of Example 16, wherein the first set of primary ESD diodes and the first resistor are dimensioned to carry less than half of an amount of current from the ESD event on the first signal pad.

Example 18 includes the system of any of Examples 16 to 17, wherein the transformer is further to provide a third ESD path for the ESD event on the first signal pad through the transformer.

Example 19 includes the system of Example 18, wherein the first set of primary ESD diodes and the first resistor are dimensioned to carry a residual amount of current from the ESD event on the first signal pad not carried by the second and third ESD paths.

Example 20 includes the system of any of Examples 16 to 19, wherein the ESD network further comprises a second set of primary ESD diodes coupled to the second signal pad through a second resistor and coupled to the first side of the transformer to provide a fourth ESD path for the ESD event on the second signal pad through the second set of primary ESD diodes, and a second set of secondary ESD diodes coupled to the second side of the transformer to provide a fifth ESD path for the ESD event on the second signal pad through the second set of secondary ESD diodes.

Example 21 includes the system of Example 20, wherein the second set of primary ESD diodes and the second resistor are dimensioned to carry less than half of an amount of current from the ESD event on the second signal pad.

Example 22 includes the system of any of Examples 20 to 21, wherein the transformer is further to provide a sixth ESD path for the ESD event on the second signal pad through the transformer.

Example 23 includes the system of Example 22, wherein the second set of primary ESD diodes and the second resistor are dimensioned to carry a residual amount of current from the ESD event on the second pad not carried by the fifth and sixth ESD paths.

Example 24 includes a method, comprising coupling an inductor in series with a signal pad, and distributing an electrostatic discharge (ESD) protection circuit before and after the inductor to provide ESD protection for an ESD event on the signal pad.

Example 25 includes the method of Example 24, further comprising providing one or more primary ESD diodes on a first side of the inductor, and providing one or more secondary ESD diodes on a second side of the inductor.

Example 26 includes the method of Example 25, further comprising providing more ESD protection from the one or more secondary ESD diodes relative to the one or more primary ESD diodes.

Example 27 includes the method of any of Examples 25 to 26, further comprising providing a higher capacitive load from the one or more secondary ESD diodes relative to the one or more primary ESD diodes.

Example 28 includes the method of any of Examples 25 to 27, further comprising limiting an amount of ESD current directed through the one or more primary ESD diodes to less than a predetermined amount of current.

Example 29 includes the method of Example 28, further comprising suppressing an overshoot at the signal pad with the one or more primary ESD diodes.

Example 30 includes the method of any of Examples 25 to 29, further comprising stacking one or more of the one or more primary ESD diodes.

Example 31 includes the method of any of Examples 24 to 30, further comprising receiving a signal at the signal pad with a frequency of at least five gigahertz.

Example 32 includes an apparatus, comprising means for coupling an inductor in series with a signal pad, and means for distributing an electrostatic discharge (ESD) protection circuit before and after the inductor to provide ESD protection for an ESD event on the signal pad.

Example 33 includes the apparatus of Example 32, further comprising means for providing one or more primary ESD diodes on a first side of the inductor, and means for providing one or more secondary ESD diodes on a second side of the inductor.

Example 34 includes the apparatus of Example 33, further comprising means for providing more ESD protection from the one or more secondary ESD diodes relative to the one or more primary ESD diodes.

Example 35 includes the apparatus of any of Examples 33 to 34, further comprising means for providing a higher capacitive load from the one or more secondary ESD diodes relative to the one or more primary ESD diodes.

Example 36 includes the apparatus of any of Examples 33 to 35, further comprising means for limiting an amount of ESD current directed through the one or more primary ESD diodes to less than a predetermined amount of current.

Example 37 includes the apparatus of Example 36, further comprising means for suppressing an overshoot at the signal pad with the one or more primary ESD diodes.

Example 38 includes the apparatus of any of Examples 33 to 37, further comprising means for stacking one or more of the one or more primary ESD diodes.

Example 39 includes the apparatus of any of Examples 32 to 38, further comprising means for receiving a signal at the signal pad with a frequency of at least five gigahertz.

The disclosure can be practiced with modification and alteration, and the scope of the appended claims is not limited to the examples so described. For example, the above examples may include specific combinations of features. However, the above examples are not limiting in this regard and, in various implementations, the above examples may include the undertaking only a subset of such features, undertaking a different order of such features, undertaking a different combination of such features, and/or undertaking additional features than those features explicitly listed. The scope of the patent rights should, therefore, be determined with reference to the appended claims, along with the full scope of equivalents to which such claims are entitled.

1. An integrated circuit (IC) device, comprising:
a signal pad;
an inductor coupled in series with the signal pad; and
an electrostatic discharge (ESD) protection circuit distributed before and after the inductor to provide ESD protection for an ESD event on the signal pad.

2. The IC device of claim 1, wherein the ESD protection circuit comprises:
one or more primary ESD diodes coupled to the signal pad and a first side of the inductor; and
one or more secondary ESD diodes coupled to a second side of the inductor.

3. The IC device of claim 2, wherein the one or more secondary ESD diodes provide more ESD protection relative to the one or more primary ESD diodes.

4. The IC device of claim 2, wherein the one or more secondary ESD diodes provide a higher capacitive load relative to the one or more primary ESD diodes.

5. The IC device of claim 2, wherein the one or more primary ESD diodes comprise:
one or more P-diodes coupled in series with one or more N-diodes; and
a resistor coupled between the signal pad and a junction of the one or more P-diodes and the one or more N-diodes.

6. The IC device of claim 5, wherein the one or more N-diodes comprise at least two stacked N-diodes.

7. The IC device of claim 1, wherein the signal pad is to be coupled to a signal with a frequency of at least five gigahertz.

8. An integrated circuit (IC) device, comprising:
a first signal pad;
a first inductor coupled in series with the first signal pad;
a first set of primary ESD diodes coupled to the first signal pad and a first side of the first inductor; and
a first set of secondary ESD diodes coupled to a second side of the first inductor.

9. The IC device of claim 8, wherein the first set of secondary ESD diodes provide a higher capacitive load relative to the first set of primary ESD diodes.

10. The IC device of claim 9, wherein the first set of primary ESD diodes comprise:
one or more P-diodes coupled in series with one or more N-diodes; and
a resistor coupled between the first signal pad and a junction of the one or more P-diodes and the one or more N-diodes.

11. The IC device of claim 8, further comprising:
a first transformer that comprises the first inductor and a second inductor;
a second transformer that comprises a third inductor and a fourth inductor;
a second signal pad coupled in series with the fourth inductor;
a second set of primary ESD diodes coupled to the second signal pad and a first side of the fourth inductor; and
a second set of secondary ESD diodes coupled to a second side of the fourth inductor.

12. The IC device of claim 11, wherein a first side of the second inductor is coupled to a first side of the third inductor, a second side of the second inductor is coupled to the second side of the fourth inductor, and a second side of the third inductor is coupled to the second side of the first inductor.

13. The IC device of claim 11, wherein the second set of secondary ESD diodes provide a higher capacitive load relative to the second set of primary ESD diodes.

14. The IC device of claim 11, wherein the first and second pads are to be respectively coupled to a differential pair of signals with a frequency of at least five gigahertz.

15. A system, comprising:
a power supply to provide a positive voltage source and a reference voltage source; and
a transceiver coupled to the power supply, the transceiver comprising:
a first signal pad to be coupled to a first signal of a differential signal pair,
a second signal pad to be coupled to a second signal of the differential signal pair,
a transformer coupled to the first and second signal pads, and
an electrostatic discharge (ESD) network distributed before and after the transformer to provide ESD protection for an ESD event on one or more of the first signal pad and the second signal pad.

16. The system of claim 15, wherein the ESD network comprises:
a first set of primary ESD diodes coupled to the first signal pad through a first resistor and coupled to a first side of the transformer to provide a first ESD path for the ESD event on the first signal pad through the first set of primary ESD diodes; and
a first set of secondary ESD diodes coupled to a second side of the transformer to provide a second ESD path for the ESD event on the first signal pad through the first set of secondary ESD diodes.

17. The system of claim 16, wherein the first set of primary ESD diodes and the first resistor are dimensioned to carry less than half of an amount of current from the ESD event on the first signal pad.

18. The system of claim 16, wherein the transformer is further to provide a third ESD path for the ESD event on the first signal pad through the transformer.

19. The system of claim 18, wherein the first set of primary ESD diodes and the first resistor are dimensioned to carry a residual amount of current from the ESD event on the first signal pad not carried by the second and third ESD paths.

20. The system of claim 16, wherein the ESD network further comprises:
a second set of primary ESD diodes coupled to the second signal pad through a second resistor and coupled to the first side of the transformer to provide a fourth ESD path for the ESD event on the second signal pad through the second set of primary ESD diodes; and
a second set of secondary ESD diodes coupled to the second side of the transformer to provide a fifth ESD path for the ESD event on the second signal pad through the second set of secondary ESD diodes.
